(19) United States
(12) Patent Application Publication
(10) Pub. No.: US 2024/0423335 A1
(43) Pub. Date: Dec. 26, 2024

(54) SUN-SHADE SYSTEM INCLUDING WIND INDICATOR

(71) Applicant: Timothy A. Canning, Raleigh, NC (US)

(72) Inventor: Timothy A. Canning, Raleigh, NC (US)

(21) Appl. No.: 18/339,182

(22) Filed: Jun. 21, 2023

(51) Int. Cl. A45B 23/00; G01P 13/02

(52) U.S. Cl. CPC A45B 23/00; G01P 13/025; A45B 2023/0006

(57) ABSTRACT

According to one aspect of the present disclosure, a system for providing shade on a surface is provided. The system may include a frame configured to engage with the surface. The system may include a canopy that includes a suspension end couplable to the frame, a trailing end extending away from the frame, and a first fastener. The system may include a first cord having a first frame end couplable to the first fastener and an first anchor end couplable to an anchor. The first frame end may be couplable to the first fastener. The system may include a second cord having a second frame end couplable to the first fastener and a first wind-indicator end couplable to a first wind indicator. The first wind indicator couplable may extend away from the surface at a second angle to indicate a wind direction.

### BACKGROUND

Embodiments of the present disclosure relate to sun-shade systems.

The harmful and damaging effects of the sun's ultraviolet rays have been well documented. These effects can be intensified in areas proximate to a body of water (e.g., beach, lake, river, stream, pool, etc.) or when the sun's light is direct. Sun-shade systems (e.g., canopies, tents, cabanas, umbrellas, etc.) were designed to provide protection from both weather and the damaging ultraviolet rays of the sun, especially at the beach. These sun-shade systems typically include a canopy, a frame, and an anchor. The anchor may be used when their is a wind or breeze that can affect the position of the sun-shade system. In these instances, the canopy is attached to the frame at one end, and the other end of the frame is typically anchored into a ground surface using the anchor. Anchoring an frame into a ground surface eliminates the need for an individual to hold the canopy in place, which enables the user to freely move in and out of the shaded area cast by the canopy.

### SUMMARY

According to one aspect of the present disclosure, a system for providing shade on a surface is provided. The system may include a frame configured to engage with the surface in a plane non-parallel to the surface. The system may include a canopy that includes a suspension end couplable to the frame, a trailing end extending away from the frame, and a first fastener located proximate to the suspension end. The system may include a first cord having a first frame end and an first anchor end. The first frame end may be couplable to the first fastener located proximate to the suspension end of the canopy. The system may include an anchor couplable to the first anchor end of the first cord and in contact with the surface at a first angle in the plane non-parallel to the surface. The system may include a second cord having a second frame end and a first wind-indicator end. The second frame end may be couplable to the first fastener located proximate to the suspension end of the canopy. The system may include a first wind indicator couplable to the first wind-indicator end of the second cord so that it extends away from the surface at a second angle in the plane non-parallel to the surface to indicate a wind direction.

According to one aspect of the present disclosure, a system for providing shade on a surface is provided. The system may include a frame configured to engage with the surface in a plane non-parallel to the surface. The system may include a canopy that includes a suspension end couplable to the frame, a trailing end extending away from the frame, and a first fastener located proximate to the suspension end. The system may include a first cord having a first frame end and an first anchor end. The first frame end may be couplable to the first fastener located proximate to the suspension end of the canopy. The system may include an anchor couplable to the first anchor end of the first cord and in contact with the surface at a first angle in the plane non-parallel to the surface, the anchor including at least one fastener. The system may include a second cord that includes a second anchor end and a wind-indicator end. The second anchor end may be couplable to the at least one fastener of the anchor. The system may include a wind indicator couplable to the wind-indicator end of the second cord so that it extends away from the surface at a second angle in the plane non-parallel to indicate a wind direction.

According to one aspect of the present disclosure, a system for providing shade on a surface is provided. The system may include a frame configured to engage with the surface in a plane non-parallel to the surface. The system may include a canopy that includes a suspension end couplable to the frame, a trailing end extending away from the frame, and a first fastener located proximate to the suspension end. The system may include a first cord having a first frame end and an first anchor end. The first frame end may be couplable to the first fastener located proximate to the suspension end of the canopy. The system may include an anchor couplable to the first anchor end of the first cord and in contact with the surface at a first angle in the plane non-parallel to the surface. The anchor may include a second fastener. The system may include a second cord having a second frame end and a first wind-indicator end. The second frame end may be couplable to the first fastener located proximate to the suspension end of the canopy. The system may include a first wind indicator couplable to the first wind-indicator end of the second cord so that it extends away from the surface at a second angle in the plane non-parallel to the surface to indicate a wind direction. The system may include a third cord having a second anchor end and a second wind-indicator end. The second anchor end may be couplable to the second fastener of the anchor. The system may include a second wind indicator couplable to the second wind-indicator end of the third cord so that it extends away from the surface at a third angle in the plane non-parallel to indicate the wind direction.

These illustrative embodiments are mentioned not to limit or define the present disclosure, but to provide examples to aid understanding thereof. Additional embodiments are described in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a diagram of a first exemplary sun-shade system, according to some embodiments of the present disclosure.

FIG. 2 illustrates a diagram of a second exemplary sun-shade system, according to some embodiments of the present disclosure.

FIG. 3 illustrates a diagram of a third exemplary sun-shade system, according to some embodiments of the present disclosure.

FIG. 4 illustrates a diagram of a third exemplary sun-shade system, according to some embodiments of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

As mentioned above in the BACKGROUND section, traditional sun-shade systems may include an anchor and cord that position the frame (onto which the canopy is attached) to a surface. However, if the vertical plane in which the frame and canopy are positioned is not substantially perpendicular to the direction of the wind, structural instability of the system may occur. For instance, if the plane in which the frame and canopy are positioned is not substantially perpendicular to the direction of the wind, the shaded area created by the canopy may be of reduced size. Moreover, without properly positioning the frame and canopy substantially perpendicular to the direction of the wind, the sun-shade system may be knocked over or shifted unexpectedly by gusts in the wind.

To overcome these and other challenges, the present disclosure provides an exemplary sun-shade system with at least one wind indicator configured to indicate the direction of the wind (also referred to as the “eye of the wind”). The at least one wind indicator may include any apparatus configured to move freely above the sun-shade system to indicate a direction of the wind. To that end, the at least one wind indicator may include, e.g., a wind sock, a wind sleeve, a cylindrical textile tube, a conical textile tube, a decorative textile, a flag, or a kite, just to name a few.

Once the wind's direction is identified based on the position of the wind indicator, a user may easily position the frame and canopy so that the plane in which they lie is substantially perpendicular to the wind. Moreover, when the wind's direction changes throughout the day, the wind indicator may be used to indicate a new position of the sun-shade system that maximizes the size of the shaded area created by the canopy, while reducing the risk of injury associated with sun-shade system collapse.

In some embodiments, the at least one wind indicator may include a single wind indicator. The single wind indicator may be couplable any portion of the sun-shade system such that it moves freely in the wind to indicate the wind's direction. For instance, in some embodiments, the wind indicator may be coupled to a fastener to which the anchor cord is couplable to the frame. Once assembled, the anchor cord coupled to the frame may form a first angle in the plane in which the frame and canopy are positioned with respect to the surface. On the other hand, when the wind indicator's cord coupled to the fastener at the frame may form a second angle in the plane in which the frame and canopy are positioned with respect to the surface.

In some embodiments, single wind indicator may be coupled to a fastener that couples the anchor cord to the anchor. Once assembled, the anchor cord may form a first angle in the plane in which the frame and canopy are positioned with respect to the surface. On the other hand, when the wind indicator cord coupled to the fastener at the anchor may form a second angle in the plane in which the frame and canopy are positioned with respect to the surface.

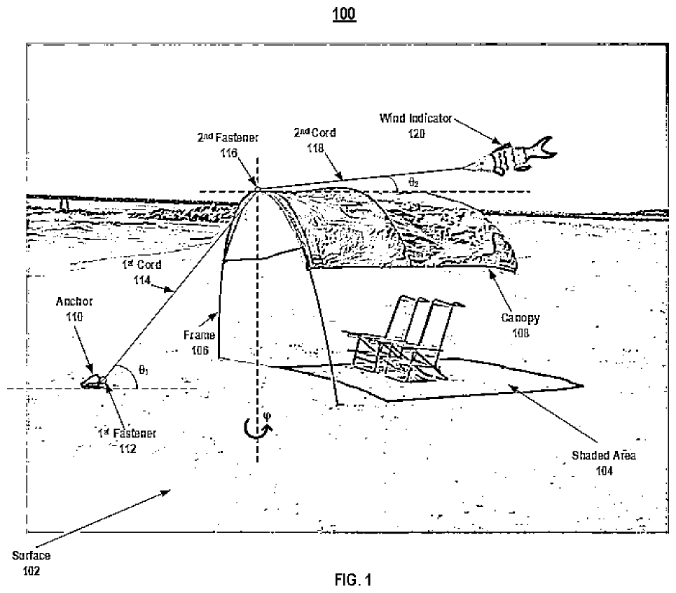

In some other embodiments, the at least one wind indicator may include two or more wind indicators. For example, the exemplary sun-shade system described below may include two wind indicators, three wind indicators, etc. In a non-limiting embodiment of two wind indicators, a first wind indicator may be coupled to a first fastener at the frame and/or canopy that also couples to the anchor cord. A second wind indicator may be coupled to a second fastener at the anchor that also couples to an opposing end of the anchor cord. The first and second wind indicators may be of the same or different type(s). For instance, the first wind indicator may include a wind sock, while the second wind indicator may include a kite. Additional details of the exemplary sun-shade system are described below in connection with FIGS. 1-4.

FIG. 1 illustrates a diagram of a first exemplary sun-shade system 100 (referred to hereinafter as “first sun-shade system 100”), according to some embodiments of the present disclosure. Referring to FIG. 1, first sun-shade system 100 may be configured to provide a shaded area 104 on a surface 102. For instance, first sun-shade system 100 may be fixed to surface 102 (e.g., beach, lawn, ground, pool deck, etc.) to provide shaded area 104. While enjoying recreation in shaded area 104, a user may be protected from the sun's harmful ultraviolet (UV) radiation. To that end, first sun-shade system 100 may include, e.g., a frame 106, a canopy 108, an anchor 110, a first anchor 112 located at anchor 110, a first cord 114 (e.g., an anchor cord), a second fastener 116 located at frame 106 and/or canopy 108, a second cord 118 (e.g., a wind-indicator cord), and a wind indicator 120.

Canopy 108 may be configured to engage with and for ariel suspension by frame 106. Canopy 108 may include at least one lightweight material, e.g., such as ripstop, polyester, blackout, light diffusion, light reflection, light modification, and/or waterproof. The lightweight material that forms canopy 108 my be unitarily constructed or include two or more coupled sections. A suspension end of canopy 108 may be positioned proximal to frame 106 when engaged therewith. To that end, the suspension end of canopy 108 may include one or more attachment portions couplable to frame 106. The one or more attachment portions may include, without limitation, hooks, loops, male and female buttons, slits, clips, ties, etc. In the non-limiting embodiment depicted in FIG. 1, canopy 108 includes a single loop that extends the entire length of the suspension end. However, in some embodiments, the loop may extend along a portion of the suspension end's length. In some other embodiments, the loop may include a plurality of loops separated by a predetermined distance along the length of the suspension end. When the suspension end is designed with one or more loops, canopy 108 may be fed through the one or more loops to couple to frame 106. Although not shown, canopy 108 may include at least one stabilizer to maintain its position relative to the frame 106. The stabilizer may include, e.g., an elastic strap, gear ties, a bungee cord, a rope, or any other material configured to stabilize the position of canopy 108 relative to frame 106.

Frame 106 may include a plurality of sections configured for end-to-end coupling. The plurality of sections may be telescopically couplable, where each section of frame 106 may be housed partially within and extend from adjacent section(s). Although not shown, a cord may be coupled to opposing ends of frame 106 and extend through each of the plurality of sections for ease of assembly and deassembly. Once assembled, the sections of frame 106 may form a curve shape as the opposing ends engage with surface 102.

First sun-shade system 100 may further include, e.g., a first cord 114 couplable to anchor 110 and frame 106 (or canopy 108) via first fastener 112 and second fastener 116, respectively. First cord 114 may be configured to provide structural support to frame 106 and canopy 108 when first sun-shade system 100 is assembled in a supporting arrangement, which is the arrangement depicted in FIG. 1. Anchor 110 may be configured for housing a weight. When surface 102 includes a beach, the weight housed by anchor 110 may include sand. However, anchor 110 may house any other weight without departing from the scope of the present disclosure.

To maintain the supporting arrangement depicted in FIG. 1, first cord 114 may be coupled to first fastener 112 (at anchor 110) and second fastener 116 (at frame 106 or canopy 108) and apply a supporting force against the wind. The supporting force may be applied to frame 106 at a first angle (θ₁) in a plane non-parallel to surface 102.

Moreover, first sun-shade system 100 may include second cord 118 that couples wind indicator 120 to frame 106 (or canopy 108) via second fastener 116. Once coupled to fastener 116, wind indicator 120 may be configured to aerially suspend above or along the top surface of canopy 108 at a second angle (θ₂) in the plane non-parallel to surface 102. Moreover, when the wind's direction changes, second cord 118 and wind indicator 120 may rotate around a vertical axis that extends through second fastener 116. This angle-of-rotation is depicted as φ in FIG. 1. As wind indicator 120 rotates it may indicate a new direction of the wind. Using the position of wind indicator 120 (e.g., θ₂ or φ), a user may position or reposition frame 106 such that the plane in which it lies is perpendicular or substantially perpendicular to the direction of the wind. By positioning or repositioning reposition frame 106, the size of shaded area 104 created by canopy 108 may be maximized (due to an ideal unfurling of canopy 108), while reducing the risk of injury associated with a collapse of first sun-shade system 100.

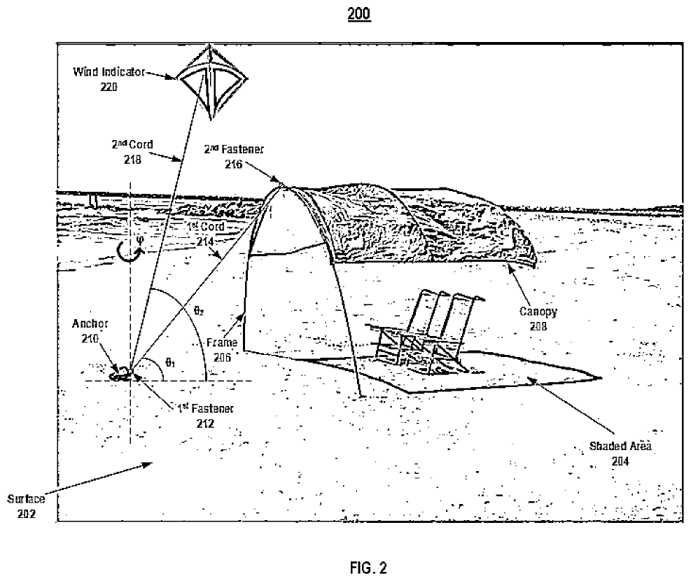

FIG. 2 illustrates a diagram of a second exemplary sun-shade system 200 (referred to hereinafter as “second sun-shade system 200”), according to some embodiments of the present disclosure. Referring to FIG. 2, second sun-shade system 200 may be configured to provide a shaded area 204 on a surface 202. For instance, second sun-shade system 200 may be fixed to surface 202 (e.g., beach, lawn, ground, pool deck, etc.) to provide shaded area 204. While enjoying recreation in shaded area 204, a user may be protected from the sun's harmful UV radiation. To that end, second sun-shade system 200 may include, e.g., a frame 206, a canopy 208, an anchor 210, a first anchor 212 located at anchor 210, a first cord 214 (e.g., an anchor cord), a second fastener 216 located at frame 206 and/or canopy 208, a second cord 218 (e.g., a wind-indicator cord), and a wind indicator 220.

Canopy 208 may be configured to engage with and for ariel suspension by frame 206. Canopy 208 may include at least one lightweight material, e.g., such as ripstop, polyester, blackout, light diffusion, light reflection, light modification, and/or waterproof. The lightweight material that forms canopy 208 my be unitarily constructed or include two or more coupled sections. A suspension end of canopy 208 may be positioned proximal to frame 206 when engaged therewith. To that end, the suspension end of canopy 208 may include one or more attachment portions couplable to frame 206. The one or more attachment portions may include, without limitation, hooks, loops, male and female buttons, slits, clips, ties, etc. In the non-limiting embodiment depicted in FIG. 2, canopy 208 includes a single loop that extends the entire length of the suspension end. However, in some embodiments, the loop may extend along a portion of the suspension end's length. In some other embodiments, the loop may include a plurality of loops separated by a predetermined distance along the length of the suspension end. When the suspension end is designed with one or more loops, canopy 208 may be fed through the one or more loops to couple to frame 206. Although not shown, canopy 208 may include at least one stabilizer to maintain its position relative to the frame 206. The stabilizer may include, e.g., an clastic strap, gear ties, a bungee cord, a rope, or any other material configured to stabilize the position of canopy 208 relative to frame 206.

Frame 206 may include a plurality of sections configured for end-to-end coupling. The plurality of sections may be telescopically couplable, where each section of frame 206 may be housed partially within and extend from adjacent section(s). Although not shown, a cord may be coupled to opposing ends of frame 206 and extend through each of the plurality of sections for ease of assembly and de-assembly. Once assembled, the sections of frame 206 may form a curve shape as the opposing ends engage with surface 202.

Second sun-shade system 200 may further include, e.g., a first cord 214 couplable to anchor 210 and frame 206 (or canopy 208) via first fastener 212 and second fastener 216, respectively. First cord 214 may be configured to provide structural support to frame 206 and canopy 208 when second sun-shade system 200 is assembled in a supporting arrangement, which is the arrangement depicted in FIG. 2. Anchor 210 may be configured for housing a weight. When surface 202 includes a beach, the weight housed by anchor 210 may include sand. However, anchor 210 may house any other weight without departing from the scope of the present disclosure.

To maintain the supporting arrangement depicted in FIG. 2, first cord 214 may be coupled to first fastener 212 (at anchor 210) and second fastener 216 (at frame 206 or canopy 208) and apply a supporting force against the wind. The supporting force may be applied to frame 206 at a first angle (θ₁) in a plane non-parallel to surface 202.

Moreover, second sun-shade system 200 may include second cord 218 that couples wind indicator 220 to frame 206 (or canopy 208) via second fastener 216. Once coupled to fastener 216, wind indicator 220 may be configured to aerially suspend above or along the top surface of canopy 208 at a second angle (θ₂) in the plane non-parallel to surface 202. Moreover, when the wind's direction changes, second cord 218 and wind indicator 220 may rotate around a vertical axis that extends through second fastener 216. This angle-of-rotation is depicted as φ in FIG. 2. As wind indicator 220 rotates it may indicate a new direction of the wind. Using the position of wind indicator 220 (e.g., θ₂ or φ), a user may position or reposition frame 206 such that the plane in which it lies is perpendicular or substantially perpendicular to the direction of the wind. By positioning or repositioning reposition frame 206, the size of shaded area 204 created by canopy 208 may be maximized (due to an ideal unfurling of canopy 208), while reducing the risk of injury associated with a collapse of second sun-shade system 200.

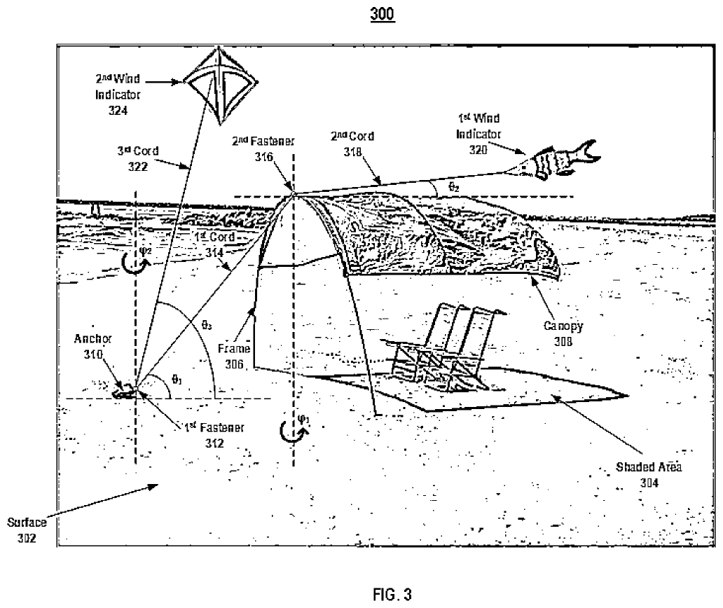

FIG. 3 illustrates a diagram of a second exemplary sun-shade system 300 (referred to hereinafter as “third sun-shade system 300”), according to some embodiments of the present disclosure. Referring to FIG. 3, third sun-shade system 300 may be configured to provide a shaded area 304 on a surface 302. For instance, third sun-shade system 300 may be fixed to surface 302 (e.g., beach, lawn, ground, pool deck, etc.) to provide shaded area 304. While enjoying recreation in shaded area 304, a user may be protected from the sun's harmful UV radiation. To that end, third sun-shade system 300 may include, e.g., a frame 306, a canopy 308, an anchor 310, a first anchor 312 located at anchor 310, a first cord 314 (e.g., an anchor cord), a second fastener 316 located at frame 306 and/or canopy 308, a second cord 318 (e.g., a wind-indicator cord), a first wind indicator 320, a third cord 322, and a second wind indicator 324.

Canopy 308 may be configured to engage with and for ariel suspension by frame 306. Canopy 308 may include at least one lightweight material, e.g., such as ripstop, polyester, blackout, light diffusion, light reflection, light modification, and/or waterproof. The lightweight material that forms canopy 308 my be unitarily constructed or include two or more coupled sections. A suspension end of canopy 308 may be positioned proximal to frame 306 when engaged therewith. To that end, the suspension end of canopy 308 may include one or more attachment portions couplable to frame 306. The one or more attachment portions may include, without limitation, hooks, loops, male and female buttons, slits, clips, ties, etc. In the non-limiting embodiment depicted in FIG. 3, canopy 308 includes a single loop that extends the entire length of the suspension end. However, in some embodiments, the loop may extend along a portion of the suspension end's length. In some other embodiments, the loop may include a plurality of loops separated by a predetermined distance along the length of the suspension end. When the suspension end is designed with one or more loops, canopy 308 may be fed through the one or more loops to couple to frame 306. Although not shown, canopy 308 may include at least one stabilizer to maintain its position relative to the frame 306. The stabilizer may include, e.g., an elastic strap, gear ties, a bungee cord, a rope, or any other material configured to stabilize the position of canopy 308 relative to frame 306.

Frame 306 may include a plurality of sections configured for end-to-end coupling. The plurality of sections may be telescopically couplable, where each section of frame 306 may be housed partially within and extend from adjacent section(s). Although not shown, a cord may be coupled to opposing ends of frame 306 and extend through each of the plurality of sections for ease of assembly and de-assembly. Once assembled, the sections of frame 306 may form a curve shape as the opposing ends engage with surface 302.

Third sun-shade system 300 may further include, e.g., a first cord 314 couplable to anchor 310 and frame 306 (or canopy 308) via first fastener 312 and second fastener 316, respectively. First cord 314 may be configured to provide structural support to frame 306 and canopy 308 when third sun-shade system 300 is assembled in a supporting arrangement, which is the arrangement depicted in FIG. 3. Anchor 310 may be configured for housing a weight. When surface 302 includes a beach, the weight housed by anchor 310 may include sand. However, anchor 310 may house any other weight without departing from the scope of the present disclosure. To maintain the supporting arrangement depicted in FIG. 3, first cord 314 may be coupled to first fastener 312 (at anchor 310) and second fastener 316 (at frame 306 or canopy 308) and apply a supporting force against the wind. The supporting force may be applied to frame 306 at a first angle (θ₁) in a plane non-parallel to surface 302.

Moreover, second cord 318 may be couplable to first wind indicator 320 and frame 306 (or canopy 308) via second fastener 316. Once coupled to second fastener 316, first wind indicator 320 may be configured to aerially suspend above or along the top surface of canopy 308 at a second angle (θ₂) in the plane non-parallel to surface 302. Moreover, when the wind's direction changes, second cord 318 and first wind indicator 320 may rotate around a vertical axis that extends through second fastener 316 and intersects with surface 302. This first angle-of-rotation is depicted as φ₁ in FIG. 3. As first wind indicator 320 rotates it may indicate a new wind direction. Using the position of first wind indicator 320 (e.g., θ₂ or φ₁), a user may position or reposition frame 306 such that the plane in which it lies is perpendicular or substantially perpendicular to the direction of the wind.

Still further, third cord 318 may be couplable to second wind indicator 324 and anchor 310 via first fastener 312. Once coupled to first fastener 312, second wind indicator 324 may be configured to aerially suspend above or along the top surface of canopy 308 at a third angle (θ₃) in the plane non-parallel to surface 302. Moreover, when the wind's direction changes, third cord 322 and second wind indicator 324 may rotate around a vertical axis that extends through first fastener 312 and intersects with surface 302. This second angle-of-rotation is depicted as θ₂ in FIG. 3. As second wind indicator 324 rotates it may indicate a new wind direction. The first angle-of-rotation and the second angle-of-rotation may be the same. Using the position of first wind indicator 320 (e.g., θ₂, θ₃, φ₁, or φ₂), a user may position or reposition frame 306 such that the plane in which it lies is perpendicular or substantially perpendicular to the direction of the wind.

By positioning or repositioning reposition frame 306 in this way, the size of shaded area 304 created by canopy 308 may be maximized (due to an ideal unfurling of canopy 308), while reducing the risk of injury associated with a collapse of third sun-shade system 300. Furthermore, the two wind indicators of third sun-shade system 300 may aid a user in identifying the location of her or his sun-shade system on a crowded beach.

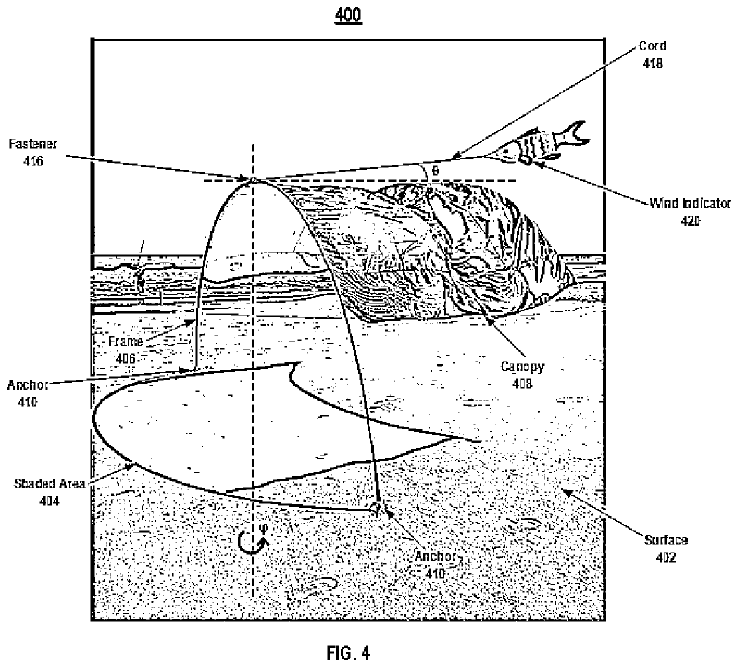

FIG. 4 illustrates a diagram of a fourth exemplary sun-shade system 400 (referred to hereinafter as “fourth sun-shade system 400”), according to some embodiments of the present disclosure. Referring to FIG. 4, fourth sun-shade system 400 may be configured to provide a shaded area 404 on a surface 402. For instance, fourth sun-shade system 400 may be fixed to surface 402 (e.g., beach, lawn, ground, pool deck, etc.) to provide shaded area 404. While enjoying recreation in shaded area 404, a user may be protected from the sun's harmful ultraviolet (UV) radiation. To that end, fourth sun-shade system 400 may include, e.g., a frame 406, a canopy 408, a pair of anchors 410, a fastener 416 located at frame 406 and/or canopy 408, a cord 418 (e.g., a wind-indicator cord), and a wind indicator 420.

Canopy 408 may be configured to engage with and for ariel suspension by frame 406. Canopy 408 may include at least one lightweight material, e.g., such as ripstop, polyester, blackout, light diffusion, light reflection, light modification, and/or waterproof. The lightweight material that forms canopy 408 may be unitarily constructed or include two or more coupled sections. A suspension end of canopy 408 may be positioned proximal to frame 406 when engaged therewith. To that end, the suspension end of canopy 408 may include one or more attachment portions couplable to frame 406. The one or more attachment portions may include, without limitation, hooks, loops, male and female buttons, slits, clips, ties, etc. In the non-limiting embodiment depicted in FIG. 4, canopy 408 includes a single loop that extends the entire length of the suspension end. However, in some embodiments, the loop may extend along a portion of the suspension end's length. In some other embodiments, the loop may include a plurality of loops separated by a predetermined distance along the length of the suspension end. When the suspension end is designed with one or more loops, canopy 408 may be fed through the one or more loops to couple to frame 406. Although not shown, canopy 408 may include at least one stabilizer to maintain its position relative to the frame 406. The stabilizer may include, e.g., an clastic strap, gear ties, a bungee cord, a rope, or any other material configured to stabilize the position of canopy 408 relative to frame 406.

Frame 406 may include a plurality of sections configured for end-to-end coupling. The plurality of sections may be telescopically couplable, where each section of frame 406 may be housed partially within and extend from adjacent section(s). Although not shown, a cord may be coupled to opposing ends of frame 406 and extend through each of the plurality of sections for ease of assembly and deassembly. Once assembled, the sections of frame 406 may form a curve shape as the opposing ends engage with surface 402.

Rather than a weighted anchor, fourth sun-shade system 400 may include, e.g., a pair of anchors 410 that fix to surface 402 for structural stability. Pair of anchors 410 may include a pair of hollow screws, which may be screwed into surface 402. The ends of frame 406 may engage with the hollow cavities in each anchor of the pair of anchors.

Moreover, fourth sun-shade system 400 may include cord 418 that couples wind indicator 420 to frame 406 (or canopy 408) via fastener 416. Once coupled to fastener 416, wind indicator 420 may be configured to aerially suspend above or along the top surface of canopy 408 at an angle (θ₂) in the plane non-parallel to surface 402. Moreover, when the wind's direction changes, second cord 418 and wind indicator 420 may rotate around a vertical axis that extends through second fastener 416. This angle-of-rotation is depicted as φ in FIG. 4. As wind indicator 420 rotates it may indicate a new direction of the wind. Using the position of wind indicator 420 (e.g., θ₂ or φ), a user may position or reposition frame 406 and at least one anchor of pair of anchors 410 such that the plane in which it lies is perpendicular or substantially perpendicular to the direction of the wind. By positioning or repositioning reposition frame 406, the size of shaded area 404 created by canopy 408 may be maximized (due to an ideal unfurling of canopy 408), while reducing the risk of injury associated with a collapse of fourth sun-shade system 400.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

What is claimed is:

1. A system for providing shade on a surface, comprising:
a frame configured to engage with the surface in a plane non-parallel to the surface;
a canopy that includes a suspension end couplable to the frame, a trailing end extending away from the frame, and a first fastener located proximate to the suspension end;
a first cord having a first frame end and an first anchor end, the first frame end couplable to the first fastener located proximate to the suspension end of the canopy;
an anchor couplable to the first anchor end of the first cord and in contact with the surface, the first cord forming a first angle in the plane non-parallel to the surface when coupled to the frame and the anchor;
a second cord having a second frame end and a first wind-indicator end, the second frame end couplable to the first fastener located proximate to the suspension end of the canopy; and
a first wind indicator couplable to the first wind-indicator end of the second cord so that it extends away from the surface at a second angle in the plane non-parallel to the surface to indicate a wind direction.

2. The system of claim 1, wherein the plane non-parallel to the surface is associated with the first angle and the second angle.

3. The system of claim 1, wherein the first wind indicator may include a wind sock, a wind sleeve, a cylindrical textile tube, a conical textile tube, a decorative textile, or a kite.

4. The system of claim 1, wherein the first wind indicator is couplable to the first fastener so that it moves freely above the canopy in the wind to indicate the wind direction.

5. The system of claim 1, further comprising:
a first connector couplable to the second frame end of the second cord and the first fastener; and
a second connector couplable to the first wind-indictor end of the second cord and the first wind indicator.

6. The system of claim 5, wherein the first connector includes a snap swivel, a ring, a carabiner, a clasp, a hook-and-eye attachment, a tie, a push-button clasp, a spring clasp, or a loop.

7. The system of claim 5, wherein the second connector includes a snap swivel, a ring, a carabiner, a clasp, a hook-and-eye attachment, a tie, a push-button clasp, a spring clasp, or a loop.

8. The system of claim 1, wherein:
the first angle and the second angle are different, or
the first angle and the second angle are the same.

9. A system for providing shade on a surface, comprising:
a frame configured to engage with the surface in a plane non-parallel to the surface;
a canopy that includes a suspension end couplable to the frame, a trailing end extending away from the frame, and a first fastener located proximate to the suspension end;
a first cord having a first frame end and an first anchor end, the first frame end couplable to the first fastener located proximate to the suspension end of the canopy;
an anchor including at least one fastener couplable to the first anchor end of the first cord and in contact with the surface, the first cord forming a first angle with the surface when coupled to the anchor and the frame;
a second cord having a second anchor end and a wind-indicator end, the second anchor end couplable to the at least one fastener of the anchor; and
a wind indicator couplable to the wind-indicator end of the second cord so that it extends away from the surface at a second angle in the plane non-parallel to indicate a wind direction.

10. The system of claim 9, wherein the plane non-parallel to the surface is associated with the first angle and the second angle.

11. The system of claim 9, wherein the wind indicator may include a wind sock, a wind sleeve, a cylindrical textile tube, a conical textile tube, a decorative textile, or a kite.

12. The system of claim 9, wherein the wind indicator is couplable to the at least one fastener so that it moves freely above the canopy in the wind to indicate the wind direction.

13. The system of claim 9, further comprising:
a first connector couplable to the anchor end of the second cord and the at least one fastener; and
a second connector couplable to the wind-indicator end of the second cord and the wind indicator.

14. The system of claim 13, wherein:
the first connector includes a first snap swivel, a first ring, a first carabiner, a first clasp, a first hook-and-eye attachment, a first tie, a first push-button clasp, a first spring clasp, or a first loop, and
the second connector includes a second snap swivel, a second ring, a second carabiner, a second clasp, a second hook-and-eye attachment, a second tie, a second push-button clasp, a second spring clasp, or a second loop.

15. The system of claim 9, wherein:
the first angle and the second angle are different, or
the first angle and the second angle are the same.

16. The system of claim 9, wherein:
the at least one fastener includes a single fastener couplable to the anchor end of the first cord and the wind-indicator end of the second cord, or
the at least one fastener includes a first fastener couplable to the anchor end of the first cord and a second fastener couplable to the wind-indicator end of the second cord.

17. A system for providing shade on a surface, comprising:
a frame configured to engage with the surface in a plane non-parallel to the surface;
a canopy that includes a suspension end couplable to the frame, a trailing end extending away from the frame, and a first fastener located proximate to the suspension end;
a first cord having a first frame end and an first anchor end, the first frame end couplable to the first fastener located proximate to the suspension end of the canopy;
an anchor including at least one fastener couplable to the first anchor end of the first cord and in contact with the surface, the first cord forming a first angle with the surface when coupled to the anchor and the frame
a second cord having a second frame end and a first wind-indicator end, the second frame end couplable to the first fastener located proximate to the suspension end of the canopy;
a first wind indicator couplable to the first wind-indicator end of the second cord so that it extends away from the surface at a second angle in the plane non-parallel to the surface to indicate a wind direction;
a third cord having a second anchor end and a second wind-indicator end, the second anchor end couplable to the second fastener of the anchor; and
a second wind indicator couplable to the second wind-indicator end of the third cord so that it extends away from the surface at a third angle in the plane non-parallel to indicate the wind direction.

18. The system of claim 17, wherein:
the first wind indicator may include a first wind sock, a first wind sleeve, a first cylindrical textile tube, a first conical textile tube, a first decorative textile, or a first kite, and
the second wind indicator may include a second wind sock, a second wind sleeve, a second cylindrical textile tube, a second conical textile tube, a second decorative textile, or a second kite.

19. The system of claim 17, wherein:
the first wind indicator is couplable to the first fastener so that the first cord moves freely along a top surface the canopy in the wind to indicate the wind direction, and
the second wind indicator is couplable to the second fastener so that the second cord moves freely above the top surface the canopy in the wind to indicate the wind direction.

20. The system of claim 17, further comprising:
a first connector couplable to the second frame end of the second cord and the first fastener;
a second connector couplable to the first wind-indictor end of the second cord and the first wind indicator;
a third connector couplable to the second anchor end of the third cord and the second fastener; and
a fourth connector couplable to the second wind-indicator end of the third cord and the second wind indicator,
wherein the first connector includes a first snap swivel, a first ring, a carabiner, a first clasp, a first hook-and-eye attachment, a first tie, a first push-button clasp, a first spring clasp, or a first loop,
wherein the second connector includes a second snap swivel, a second ring, a carabiner, a second clasp, a second hook-and-eye attachment, a second tie, a second push-button clasp, a second spring clasp, or a second loop,
wherein the third connector includes a third snap swivel, a third ring, a carabiner, a third clasp, a third hook-and-eye attachment, a third tie, a third push-button clasp, a third spring clasp, or a third loop, and
wherein the fourth connector includes a fourth snap swivel, a fourth ring, a carabiner, a fourth clasp, a fourth hook-and-eye attachment, a fourth tie, a fourth push-button clasp, a fourth spring clasp, or a fourth loop.
